(19) United States
(12) Patent Application Publication
(10) Pub. No.: US 2026/0262096 A1
(43) Pub. Date: Sep. 3, 2026

(54) RANDOM ACCESS CHANNEL PROCEDURE ON VIRTUAL CELLS

(71) Applicant: QUALCOMM Incorporated, San Diego, CA (US)

(72) Inventors: Aria HASANZADEZONUZY, Chatham, NJ (US); Kianoush HOSSEINI, San Diego, CA (US); Mostafa KHOSHNEVISAN, San Diego, CA (US); Jing SUN, San Diego, CA (US)

(21) Appl. No.: 19/068,893

(22) Filed: Mar. 3, 2025

(51) Int. Cl. H04W 74/0833; H04L 27/26; H04W 56/00

(52) U.S. Cl. CPC H04W 74/0833; H04L 27/26025; H04W 56/0005

(57) ABSTRACT

Various aspects of the present disclosure generally relate to wireless communication. In some aspects, a user equipment (UE) may receive configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located. The UE may transmit a first random access channel (RACH) message on the first band using the first configuration associated with the first TAG. The UE may transmit a second RACH message on the second band using the second configuration associated with the second TAG. Numerous other aspects are described.

### FIELD OF THE DISCLOSURE

Aspects of the present disclosure generally relate to wireless communication and specifically relate to techniques, apparatuses, and methods associated with a random access channel procedure on virtual cells.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A user equipment (UE), in some wireless communication systems (e.g., New Radio (NR) wireless telecommunications systems, or other radio access technologies (RATs) beyond NR), may perform one or more procedures for establishing a communications link with a network node that is operating as part of a wireless communication network. The UE may communicate a set of messages with the network node to establish access to the network. Establishing access to the network may be referred to as initial access. In some examples, the UE may perform a random access procedure to establish access to the wireless communication network via the network node (e.g., to establish a communication connection including an uplink connection or a downlink connection). The random access procedure may also be referred to as a random access channel (RACH) procedure. In some examples, the UE may perform a RACH procedure including a four-step random access procedure or a two-step random access procedure.

As part of a four-step RACH procedure, the UE may transmit, and the network node may receive, a first message (msg1) via a physical random access channel (PRACH). The msg1 may include a PRACH preamble. The UE may receive, and the network node may transmit, a second message (msg2) via a physical downlink control channel (PDCCH) or via a physical downlink shared channel (PDSCH) based on transmitting the msg1. The msg 2 may include a random access response (RAR) message that schedules a physical uplink shared channel (PUSCH) transmission by the UE. For example, the msg2 may indicate or allocate uplink resources via which the UE may transmit a PUSCH message. The UE may transmit, and the network node may receive, a third message (msg3) including the PUSCH message or the UE may transmit, and the network node may receive, the msg3 via the PUSCH resources. The UE may receive, and the network node may transmit, a fourth message (msg4) that includes a contention resolution message via the PDCCH or PDSCH. For example, the UE may analyze the contention resolution message to identify whether the msg4 includes identification information (e.g., a radio network temporary identifier) that matches with the identification information of the UE (e.g., as opposed to identification information associated with a different UE). If the msg4 includes identification information associated with the UE, the UE may proceed with establishing the connection. Otherwise, the UE may restart the four-step RACH procedure, for example, by retransmitting the msg1 or transmitting a second msg1.

As part of a two-step RACH procedure, the UE may transmit, and the network node may receive, a first message (msgA) including a PRACH preamble and including content similar to the content of the msg3 of the four-step RACH procedure, described above. The msgA transmission may include two transmissions. For example, a first transmission may include a PRACH preamble via the PRACH, and may include timing information for uplink transmissions (e.g., timing information that enables the network node to set timing advance parameters). A second transmission may include the remaining content of the msgA. For example, the msgA may additionally include a payload (e.g., a data payload) transmitted via the PUSCH that includes at least the msg3 contents. In some examples, the UE may transmit, and the network node may receive, a second message (msgB) including content similar to the contents of msg2 or msg4 of the four-step RACH procedure.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating examples of carrier aggregation.

FIG. 4 is a diagram illustrating an example of a virtual cell.

FIG. 5 is a diagram illustrating an example of downlink and uplink transmissions.

FIG. 6 is a diagram illustrating examples of virtual cells with multiple timing advance values.

FIGS. 7A-7B are diagrams illustrating an example associated with a random access channel procedure on virtual cells.

FIG. 8 is a diagram illustrating an example process performed, for example, at a user equipment or an apparatus of a user equipment.

FIG. 9 is a diagram illustrating an example process performed, for example, at a network node or an apparatus of a network node.

FIG. 10 is a diagram of an example apparatus for wireless communication.

FIG. 11 is a diagram of an example apparatus for wireless communication.

### SUMMARY

Some aspects described herein relate to a method of wireless communication performed by a user equipment (UE). The method may include receiving configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located. The method may include transmitting a first random access channel (RACH) message on the first band using the first configuration associated with the first TAG. The method may include transmitting a second RACH message on the second band using the second configuration associated with the second TAG.

Some aspects described herein relate to a method of wireless communication performed by a network node. The method may include transmitting configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The method may include receiving a first RACH message on the first band using the first configuration associated with the first TAG. The method may include receiving a second RACH message on the second band using the second configuration associated with the second TAG.

Some aspects described herein relate to a UE. The UE may include a processing system. The processing system may include one or more processors and one or more code-storing memories coupled with the one or more processors. The processing system may be configured to cause the UE to receive configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The processing system may be configured to cause the UE to transmit a first RACH message on the first band using the first configuration associated with the first TAG. The processing system may be configured to cause the UE to transmit a second RACH message on the second band using the second configuration associated with the second TAG.

Some aspects described herein relate to a network node. The network node may include a processing system. The processing system may include one or more processors and one or more code-storing memories coupled with the one or more processors. The processing system may be configured to cause the network node to transmit configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The processing system may be configured to cause the network node to receive a first RACH message on the first band using the first configuration associated with the first TAG. The processing system may be configured to cause the network node to receive a second RACH message on the second band using the second configuration associated with the second TAG.

Some aspects described herein relate to a non-transitory computer-readable medium that stores a set of instructions for wireless communication by a UE. The set of instructions, when executed by one or more processors of the UE, may cause the UE to receive configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The set of instructions, when executed by one or more processors of the UE, may cause the UE to transmit a first RACH message on the first band using the first configuration associated with the first TAG. The set of instructions, when executed by one or more processors of the UE, may cause the UE to transmit a second RACH message on the second band using the second configuration associated with the second TAG.

Some aspects described herein relate to a non-transitory computer-readable medium that stores a set of instructions for wireless communication by a network node. The set of instructions, when executed by one or more processors of the network node, may cause the network node to transmit configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The set of instructions, when executed by one or more processors of the network node, may cause the network node to receive a first RACH message on the first band using the first configuration associated with the first TAG. The set of instructions, when executed by one or more processors of the network node, may cause the network node to receive a second RACH message on the second band using the second configuration associated with the second TAG.

Some aspects described herein relate to an apparatus for wireless communication. The apparatus may include means for receiving configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The apparatus may include means for transmitting a first RACH message on the first band using the first configuration associated with the first TAG. The apparatus may include means for transmitting a second RACH message on the second band using the second configuration associated with the second TAG.

Some aspects described herein relate to an apparatus for wireless communication. The apparatus may include means for transmitting configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The apparatus may include means for receiving a first RACH message on the first band using the first configuration associated with the first TAG. The apparatus may include means for receiving a second RACH message on the second band using the second configuration associated with the second TAG.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### DETAILED DESCRIPTION

Carrier aggregation is a technology that enables two or more component carriers (CCs, sometimes referred to as carriers) to be combined (e.g., into a single channel) for a single UE 120 to enhance data capacity. Carriers can be combined in the same or different frequency bands. Additionally, or alternatively, contiguous or non-contiguous carriers can be combined. A network node may configure carrier aggregation for a UE, such as in a radio resource control (RRC) message, downlink control information (DCI), or another signaling message. A virtual cell (vCell) is an entity that includes a plurality of different resources (e.g., bands) aggregated together to form a single, logical cell. For example, a vCell may include a plurality of sub-bands (SBs), cells, or CCs, which are aggregated to form a single vCell. By aggregating different types of frequency resources, vCells may provide improved speeds and reliability, relative to carrier aggregation.

In wireless communication technologies like 4G/LTE and 5G/NR, a timing advance (TA) value is used to control a timing of uplink transmissions by a UE such that the uplink transmissions are received by a network node at a time that aligns with an internal timing of the network node. A network node may determine the TA value by measuring a time difference between reception of uplink transmissions from the UE and a subframe timing used by the network node. The network node may transmit a TA command (TAC) to instruct the UE to transmit future uplink communications earlier or later to reduce or eliminate the time difference and align timing between the UE and network node. If TA commands were not used, then uplink transmissions from different UEs (e.g., located at different distances from the network node) may collide due to mistiming even if the uplink transmissions are scheduled for different subframes.

When a vCell includes bands associated with a single TA, the single TA may be applied to each communication across the different bands of the vCell. For example, when a vCell includes a set of bands associated with a single network node or with a set of network nodes that are co-located, the UE may experience only a single propagation delay on each band of the set of bands. In a RACH procedure, a UE may determine a TA value in connection with receiving configuration signaling, such as a system information block (SIB) or synchronization signal block (SSB). When the RACH procedure is performed on a single band, the UE may receive the configuration signaling on the single band and apply a TA value to uplink transmissions on the single band. When the UE performs a RACH procedure on the vCell across a plurality of bands, and where each component of a vCell (e.g., each network node for each band) is co-located, the UE experiences and can apply a single TA value for each uplink transmission on each band. In this example, by transmitting the plurality of transmissions of the RACH procedure across different bands of the vCell, the UE may achieve improved throughput and reliability relative to transmitting each of the plurality of transmissions on the same band.

However, when components of the vCell are non-co-located, the UE may experience different propagation delays for transmissions on different bands of the vCell, resulting in the single TA value not being applicable for all uplink transmissions. In other words, the UE may receive configuration signaling on a first band and determine a TA value for the first band, but may transmit a physical RACH (PRACH) transmission on a second band which is associated with a different TA value with which the UE has not been configured. To avoid colliding transmissions, a network may allocate contention-free RACH resources on some bands and may allow the UE to transmit a PRACH after contention resolution, thereby obviating a lack of TA synchronization. However, such a scenario may reduce scheduling flexibility across the bands and cause additional overhead and delay associated with completing a contention resolution procedure, such as a listen-before-talk (LBT) procedure.

Various aspects relate generally to performing a RACH procedure on vCells. Some aspects more specifically relate to timing synchronization for a RACH procedure on a vCell with non-co-located bands. In some aspects, a UE may receive configuration information, such as via vCell system information, identifying a first configuration for a first band of a first timing advance group (TAG) and a second configuration for a second band of a second TAG. In some aspects, the UE may transmit a first RACH message using the first configuration and a second RACH message using the second configuration. In some aspects, different TAGs of a vCell may be associated with different dedicated RACH resource pools, which are indicated to the UE via vCell system information. In some aspects, the network node may have a RACH response window associated with each TAG of the vCell, and may indicate the RACH response windows via vCell system information, such that the UE can monitor for a RACH response message on a selected band and in a corresponding RACH response window.

Particular aspects of the subject matter described in this disclosure can be implemented to realize one or more of the following potential advantages. In some examples, the described techniques can be used to synchronize timing for RACH communications on a vCell with non-co-located bands. In some examples, the described techniques can be used to avoid communication collisions associated with a UE communicating on a vCell. In some examples, the described techniques can be used to avoid dropped communications associated with a UE monitoring for a RACH response message on a band of a vCell.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

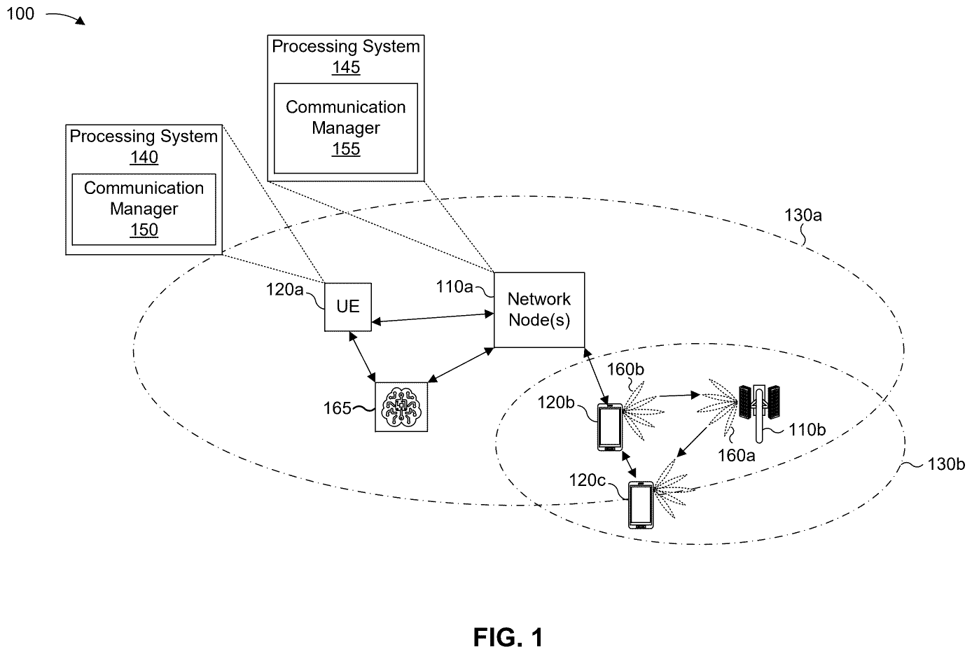

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located; transmit a first random access channel (RACH) message on the first band using the first configuration associated with the first TAG; and transmit a second RACH message on the second band using the second configuration associated with the second TAG. Additionally, or alternatively, the communication manager 150 may perform one or more other operations described herein.

In some aspects, the network node 110 may include a communication manager 155. As described in more detail elsewhere herein, the communication manager 155 may transmit configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located; receive a first RACH message on the first band using the first configuration associated with the first TAG; and receive a second RACH message on the second band using the second configuration associated with the second TAG. Additionally, or alternatively, the communication manager 155 may perform one or more other operations described herein.

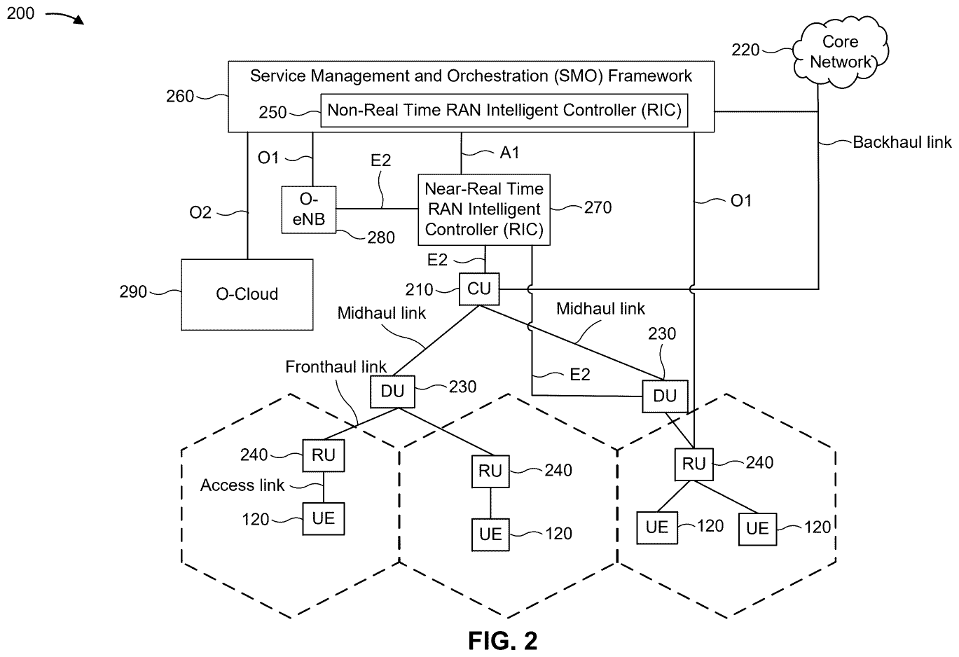

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

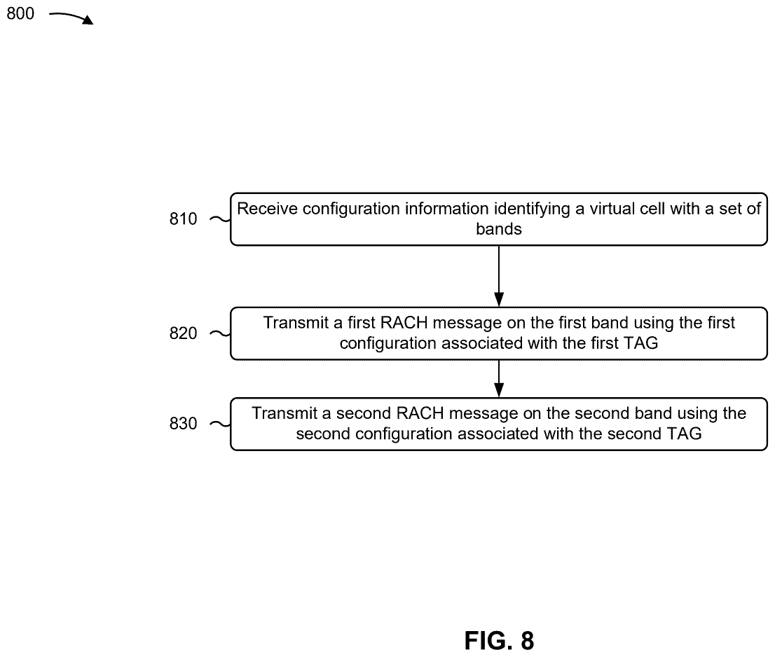

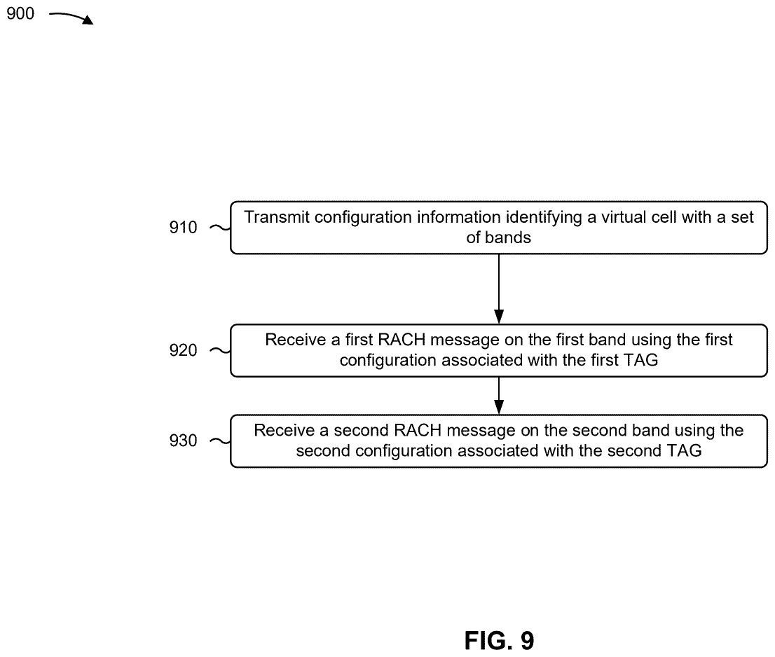

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with performing a RACH procedure on multiple virtual cells, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, or interpreting the instructions, among other examples.

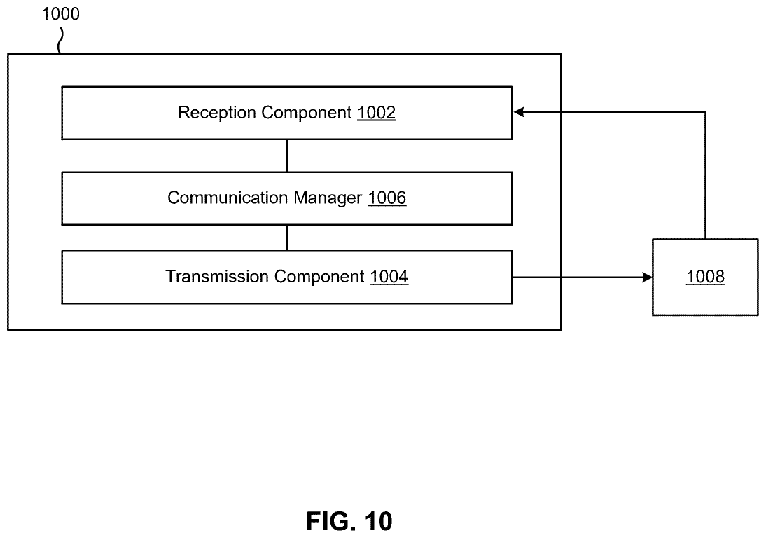

In some aspects, the UE 120 includes means for receiving configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located; means for transmitting a first RACH message on the first band using the first configuration associated with the first TAG; or means for transmitting a second RACH message on the second band using the second configuration associated with the second TAG. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

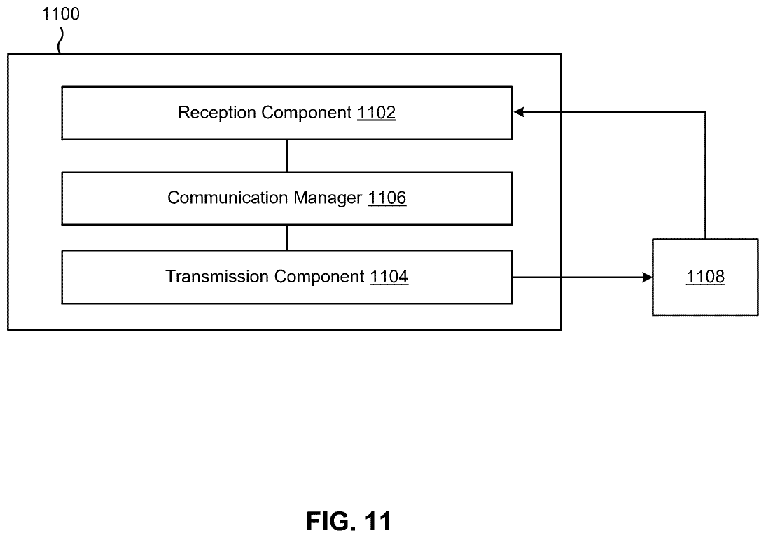

In some aspects, the network node 110 includes means for transmitting configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located; means for receiving a first RACH message on the first band using the first configuration associated with the first TAG; or means for receiving a second RACH message on the second band using the second configuration associated with the second TAG. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), or a transmission component (for example, transmission component 1104 depicted and described in connection with FIG. 11), among other examples.

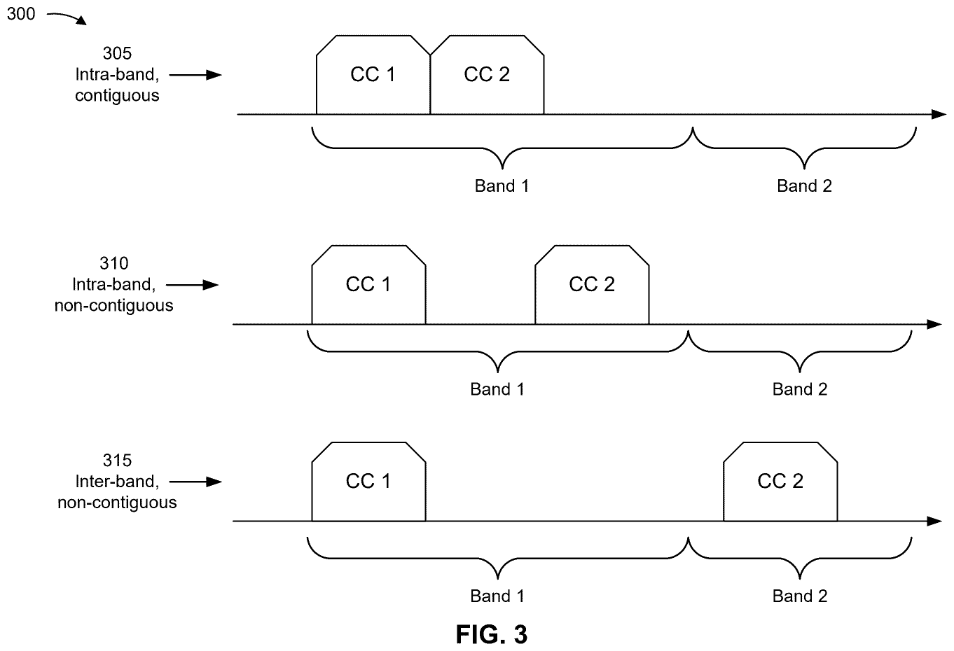

FIG. 3 is a diagram illustrating examples 300 of carrier aggregation.

Carrier aggregation (CA) is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in a radio resource control (RRC) message, downlink control information (DCI), a medium access control (MAC) control element (MAC-CE) message, a system information (SI) message, or another signaling message.

As shown by reference number 305, in some examples, carrier aggregation may be configured in an intra-band contiguous mode where the aggregated carriers are contiguous to one another and are in the same band. As shown by reference number 310, in some examples, carrier aggregation may be configured in an intra-band non-contiguous mode where the aggregated carriers are non-contiguous to one another and are in the same band. As shown by reference number 315, in some examples, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some examples, the primary carrier may carry control information (e.g., DCI or scheduling information) for scheduling data communications on one or more secondary carriers, which may be referred to as cross-carrier scheduling. In some examples, a carrier (e.g., a primary carrier or a secondary carrier) may carry control information for scheduling data communications on the carrier, which may be referred to as self-carrier scheduling or carrier self-scheduling.

As indicated above, FIG. 3 is provided as an example. Other examples may differ from what is described with regard to FIG. 3.

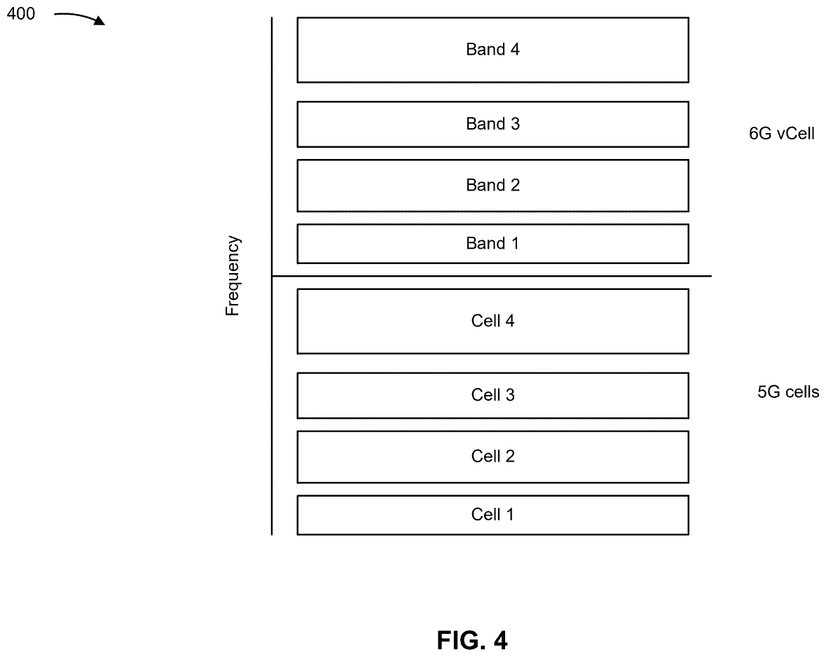

FIG. 4 is a diagram illustrating examples 400 of a virtual cell (vCell).

In CA operation, two or more component carriers (CCs, sometimes referred to as carriers) may be combined (e.g., into a single channel) for a single UE 120 to enhance data capacity. In vCell operation, two or more bands may be combined into a single virtual cell with a common configuration. For example, a vCell may be a logical entity that includes a plurality of bands, such as a plurality of sub-bands, cells, or CCs. In 5G, a frequency segment may be divided into a plurality of cells, as shown, such as a first cell, a second cell, a third cell, and a fourth cell. In contrast, with vCell operation, a frequency segment (which may or may not be contiguous) may be aggregated into a single logical cell, which is referred to as a vCell, as shown. For example, a vCell may include a first sub-band (SB1), a second sub-band (SB2), a third sub-band (SB3), and a fourth sub-band (SB4). Accordingly, a UE may use a RACH procedure to obtain initial access to the vCell, which may provide access to each of the component bands thereof.

As indicated above, FIG. 4 is provided as an example. Other examples may differ from what is described with regard to FIG. 4.

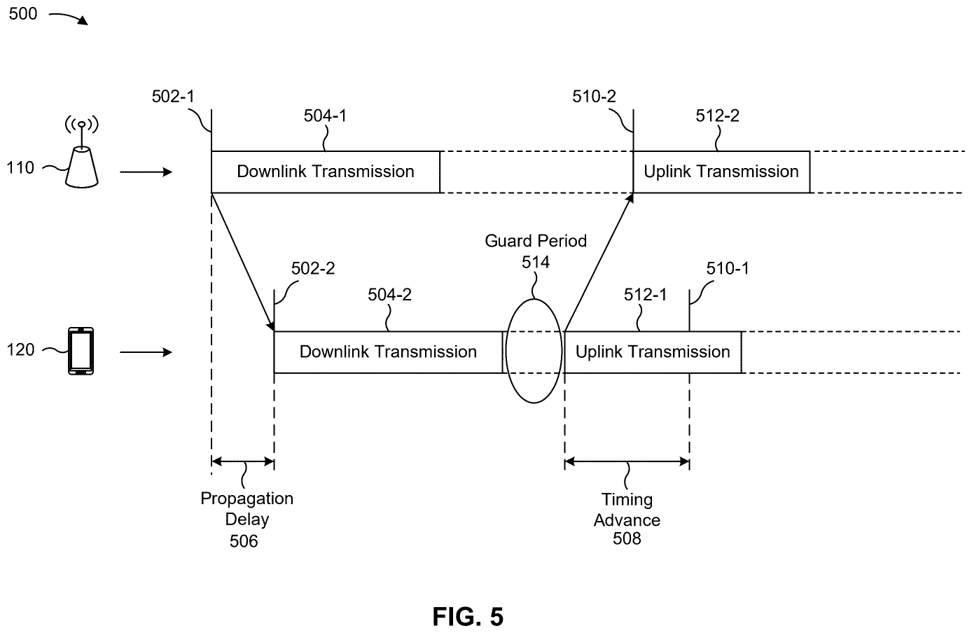

FIG. 5 is a diagram illustrating an example 500 of downlink and uplink transmissions. The downlink and uplink transmissions may be between a network node 110 and a UE 120 in the wireless communication network 100. In some examples, the downlink or uplink transmissions are based at least in part on a timing advance or a guard period between communications. As one example, a network node 110 may configure a downlink transmission to end before the start of a guard period. As another example, the UE 120 may advance a start time for an uplink transmission based at least in part on a timing advance.

As shown by reference number 502-1, a network node 110 may begin a downlink transmission 504-1 to a UE 120 at a first point in time. In some examples, the first point in time may be based at least in part on a timing scheme defined by a telecommunication system or telecommunication standard. To illustrate, the telecommunication standard may define various time partitions for scheduling transmissions between devices. As one example, the timing scheme may define radio frames (sometimes referred to as frames), where each radio frame has a predetermined duration (e.g., 10 milliseconds (msec)). Each radio frame may be further partitioned into a set of Z (Z≥1) subframes, where each subframe may have a predetermined duration (e.g., 1 msec). Each subframe may be further partitioned into a set of slots or each slot may include a set of L symbol periods (e.g., fourteen symbol periods, seven symbol periods, or another number of symbol periods). Thus, the first point in time as shown by the reference number 502-1 may be based at least in part on a time partition as defined by a telecommunication system (e.g., a frame, a subframe, a slot, a mini-slot, or a symbol).

In some examples, the network node 110 and the UE 120 may wirelessly communicate with one another (e.g., directly or via one or more network nodes) based at least in part on the defined time partitions. However, each device may have different timing references for the time partitions. To illustrate, and as shown by the reference number 502-1, the network node 110 may begin the downlink transmission 504-1 at a point in time that may be associated with a defined time partition based at least in part on a time perspective of the network node 110. For example, the network node 110 may associate the point in time with a defined time partition, such as a beginning of a symbol, a beginning of a slot, a beginning of a subframe, or a beginning of a frame. However, the downlink transmission may incur a propagation delay 506 in time, such as a time delay based at least in part on the downlink transmission traveling between a network node 110 (e.g., an RU) and the UE 120. As shown by reference number 502-2, the UE 120 may receive downlink transmission 504-2 (corresponding to downlink transmission 504-1 transmitted by the network node 110) at a second point in time that is later in time relative to the first point in time. From a time perspective of the UE 120, however, the UE 120 may associate the second point in physical time shown by the reference number 502-2 with the same point in time of the defined time partition as the network node 110 (e.g., a beginning of the same symbol, a beginning of the same mini-slot, a beginning of the same slot, a beginning of the same subframe, or a beginning of the same frame). Thus, as shown by the example 500, the time perspective of the UE 120 may be delayed in time from the time perspective of the network node 110.

In wireless communication technologies like 4G/LTE and 5G/NR, a timing advance (TA) value is used to control a timing of uplink transmissions by a UE (e.g., UE 120 or the like) such that the uplink transmissions are received by a network node 110 (e.g., an RU) at a time that aligns with an internal timing of the network node 110. A network node 110 may determine the TA value to a UE (e.g., directly or via one or more network nodes) by measuring a time difference between reception of uplink transmissions from the UE and a subframe timing used by the network node 110 (e.g., by determining a difference between when the uplink transmissions were supposed to have been received by the network node 110, according to the subframe timing, and when the uplink transmissions were actually received). The network node 110 may transmit a TA command (TAC) to instruct the UE to transmit future uplink communications earlier or later to reduce or eliminate the time difference and align timing between the UE and network node 110. The TA command is used to offset timing differences between the UE and the network node 110 due to different propagation delays that occur when the UE is different distances from the network node 110. If TA commands were not used, then uplink transmissions from different UEs (e.g., located at different distances from the network node 110) may collide due to mistiming even if the uplink transmissions are scheduled for different subframes.

To illustrate, without adjusting a start time of an uplink transmission, the UE 120 may be configured to begin an uplink transmission at a scheduled point in time based at least in part on the defined time partitions as described elsewhere herein. As shown by reference number 510-1, a start of the scheduled point in time may occur at a third physical point in time based at least in part on the timing perspective of the UE 120. However, and as shown by reference number 510-2, the scheduled point in time with reference to the timing perspective of the network node 110 (e.g., an RU) may occur at a fourth point in physical time that occurs before the third point in physical time as shown by the reference number 510-1. Accordingly, the network node 110 may instruct the UE 120 (e.g., directly or via one or more network nodes) to apply a timing advance 508 to an uplink transmission to better align reception of the uplink transmission with the timing perspective of the network node 110. However, in some examples, the fourth point in time shown by the reference number 510-2 may occur at or near a same physical point in time as the third point in time shown by the reference number 510-1 such that uplink transmissions from the UE 120 to the network node 110 incur the propagation delay 506. In such a scenario, the network node 110 may instruct the UE 120 to apply a timing advance with a time duration corresponding to the propagation delay 506.

As shown by the example 500, the UE 120 may adjust a start time of an uplink transmission 512-1 based at least in part on the timing advance 508 and the start of the scheduled point in time (e.g., at the third physical point in time shown by the reference number 510-1). Based at least in part on propagation delay, the network node 110 may receive an uplink transmission 512-2 (corresponding to the uplink transmission 512-1 transmitted by the UE 120) at the fourth point in physical time shown by the reference number 510-2.

In some examples, a timing advance value may be based at least in part on twice an estimated propagation delay (e.g., the propagation delay 506) or may be based at least in part on a round trip time (RTT). A network node 110 (e.g., a DU or a CU) may estimate the propagation delay or select a timing advance value based at least in part on communications with the UE 120. As one example, the network node 110 may estimate the propagation delay based at least in part on a network access request message from the UE 120. Additionally, or alternatively, the network node 110 may estimate or select the timing advance value from a set of fixed timing advance values.

In some examples, a telecommunication system or telecommunication standards may define a guard period 514 (e.g., a time duration) between transmissions to provide a device with sufficient time for switching between different transmission or reception modes, for transient settling, to provide a margin for timing misalignment between devices, or for propagation delays. In some examples, a guard period is a period during which no transmissions or receptions are scheduled or allowed to occur. A guard period may provide a device with sufficient time to reconfigure hardware or allow the hardware to settle within a threshold value to enable a subsequent transmission. The guard period 514 may sometimes be referred to as a gap, a switching guard period, or a guard interval.

In some examples, a network node 110 (e.g., a DU or a CU) may select a starting transmission time or a transmission time duration based at least in part on a receiving device or the guard period. For example, the network node 110 may select an amount of content (e.g., data or control information) to transmit in the downlink transmission 504-1 based at least in part on beginning the transmission at the first point in time shown by the reference number 502-1 or the UE 120 completing reception of the downlink transmission 504-2 prior to a starting point of the guard period 514. Alternatively, or additionally, the UE 120 may select an amount of content (e.g., data or control information) to transmit in the uplink transmission 512-1 based at least in part on the timing advance 508, the third point in time shown by the reference number 510-1, or refraining from beginning the uplink transmission 512-1 until the guard period 514 has ended.

As indicated above, FIG. 5 is provided as an example. Other examples may differ from what is described with regard to FIG. 5.

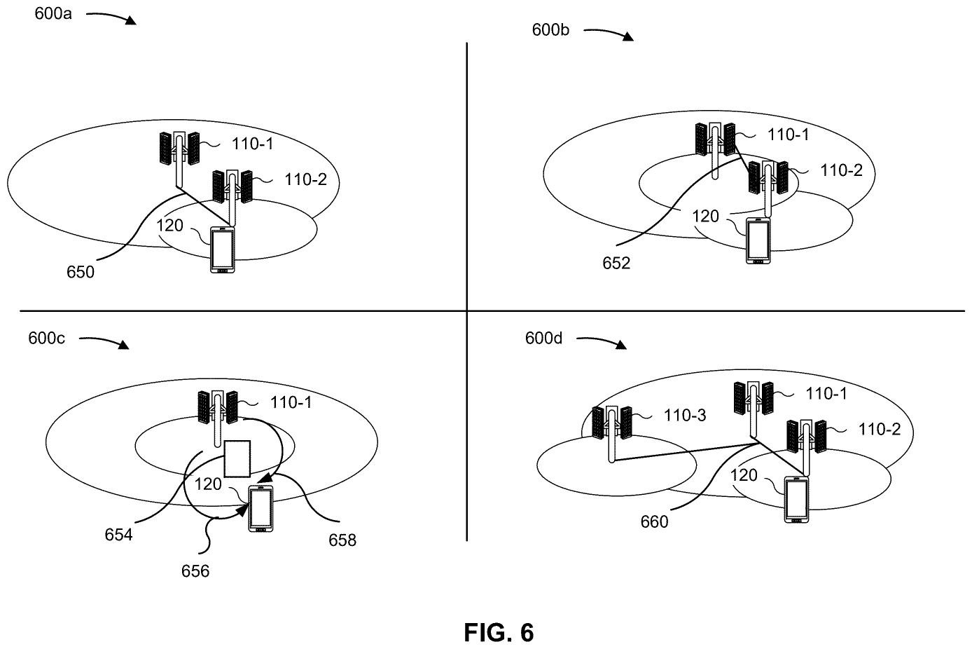

FIG. 6 is a diagram illustrating examples 600a-600d of virtual cells with multiple TA values.

As shown in FIG. 6, and by example 600a, a wireless communications network may include a network node 110-1, a network node 110-2, and a UE 120. The network node 110-1 (e.g., a first RU) may be associated with providing a first band (e.g., FR1) and the network node 110-2 (e.g., a second RU) may be associated with providing a second band (e.g., FR2). As shown by reference number 650, the network node 110-1 and the network node 110-2 may be connected via a fiber connection. In the example 600a, a vCell may include non-co-located sub-bands when the vCell is configured with both the first band and the second band. Accordingly, the UE 120 may experience a first TA value for the first band via the first network node 110-1 and a second TA value for the second band via the second network node 110-2.

As further shown in FIG. 6, and by example 600b, sub-bands of a vCell may be co-located, but coverage of a sub-band may be extended with a repeater. In other words, in the example 600b, a single network node 110-1 provides both the first band and the second band and communicates with a second network node 110-2 via a wireless backhaul, as shown by reference number 652. The second network node 110-2 provides extended coverage for the second band (e.g., FR2), resulting in the UE 120 (when in a coverage area of the second node 110-2) experiencing a first TA for the first band from the first network node 110-1 directly and a second TA for the second band from the first network node 110-1 indirectly via the second network node 110-2.

As further shown in FIG. 6, and by example 600c, different signal paths may result in different TA values. For example, a single network node 110-1 may provide both a first band and a second band, but an interfering object 654 (e.g., a building) may result in the UE 120 communicating on a first path 656 for the first band and a second path 658 for the second band. Accordingly, the UE 120 may experience a first TA value on the first path 656 and a second TA value on the second path 658.

As further shown in FIG. 6, and by example 600d, a wireless communication network may have a plurality of TRPs deployed via fiber connections. For example, a wireless communication network may include a first network node 110-1 providing a first band and may have a second network node 110-2 and a third network node 110-3, connected to the first network node 110-1 via a fiber as shown by reference number 660, providing a second band. Accordingly, the UE 120 may experience different TAs for communications with each of the three network nodes 110, as shown.

As indicated above, FIG. 6 is provided as an example. Other examples may differ from what is described with regard to FIG. 6.

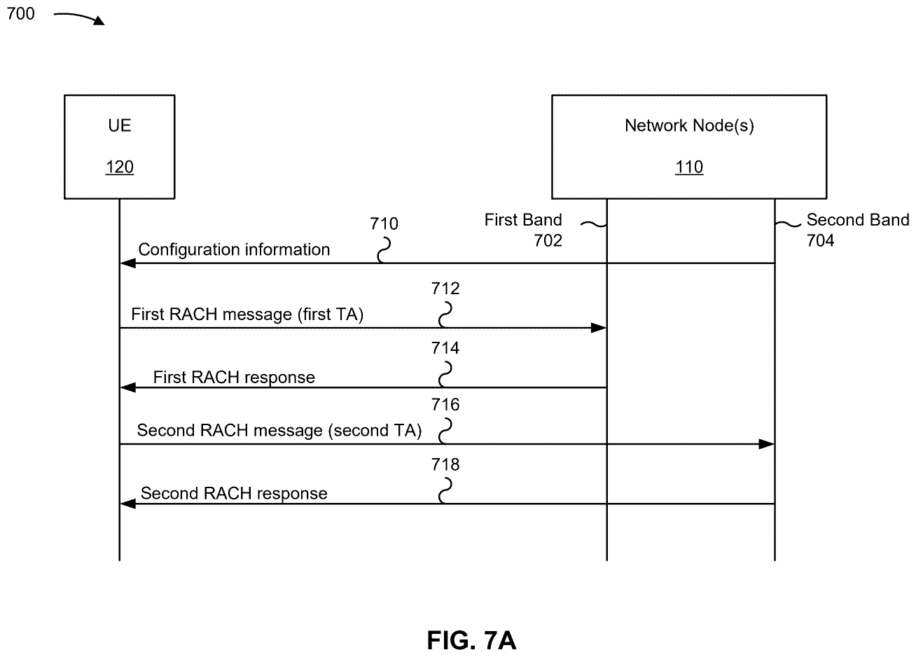

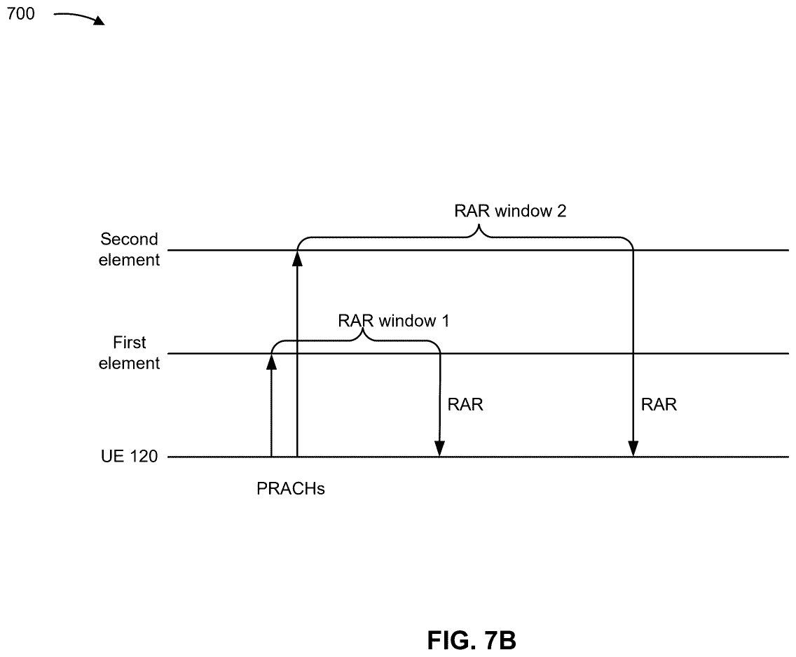

FIGS. 7A-7B are diagrams illustrating an example 700 associated with a RACH procedure on vCells. As shown in FIG. 7A, example 700 includes communication between one or more network nodes 110 and a UE 120. The UE 120 may communicate with the one or more network nodes 110 via a first band 702 and a second band 704 of a vCell.

As further shown in FIG. 7A, and by reference number 710, the UE 120 may receive configuration information. For example, the UE 120 may receive the configuration information from a network node 110 on the second band 704. In some aspects, the network node 110 may convey the configuration information via a system information (SI) communication (e.g., a vCell SI communication) or a synchronization signal block (SSB) communication. Additionally, or alternatively, the network node 110 may convey the configuration information via a radio resource control (RRC) communication, a downlink control information (DCI) communication, or a medium access control (MAC) control element (MAC-CE) communication, among other examples. Additionally, or alternatively, the network node 110 may convey the configuration information via cell-specific signaling, such as vCell-specific signaling.

Additionally, or alternatively, the network node 110 may convey the configuration information via a RACH message. For example, rather than conveying the configuration information (or all of the configuration information) prior to the transmission of a first RACH message, as described below, a network node 110 may convey the configuration information (or at least a portion of the configuration information) via a random access response (RAR) message. For example, based on the UE 120 transmitting a first RACH message to a network node 110, the network node 110 may transmit an RAR message that conveys configuration information, such as a TA value for a band, as described below.

In some aspects, the configuration information may include information associated with identifying elements of a vCell. For example, the vCell includes a plurality of elements (e.g., bands, sub-bands, cells, carriers, or CCs) that are divided into a plurality of timing advance groups (TAGs). For example, the first band 702 may be associated with a first TAG and the second band 702 may be associated with a second TAG. In some aspects, the configuration information may include information identifying one or more TAGs or one or more elements of the one or more TAGs. In some aspects, the configuration information may identify a RACH resource pool for a TAG. For example, the one or more network nodes 110 may configure a first RACH resource pool for a first TAG with the first band 702 and a second RACH resource pool for a second TAG with the second band 704. In this case, the one or more network nodes 110 may convey the configuration information via an RAR message (e.g., RACH msg2, as described above, conveying a plurality of TA commands for a plurality of TAGs). In this example, the UE 120 may be configured with a connection rule for a vCell. For example, the UE 120 may be configured to transmit a first RACH message (e.g., a first physical RACH (PRACH) message) via dedicated RACH resources and may be configured to transmit other PRACH messages on other RACH resources.

In some aspects, the configuration information may include an indication of whether RACH is supported on a plurality of TAGs in the vCell. For example, the UE 120 may receive vCell SI for a vCell with a plurality of elements assigned to a plurality of TAGs and the vCell SI may have an indication of whether the UE 120 can perform a RACH procedure using elements of the plurality of TAGs (rather than one or more elements of a single TAG). Additionally, or alternatively, the configuration information may include an indication of which element (e.g., which band) the UE 120 is to use for a RACH procedure. In some aspects, the configuration information may include an instruction to transmit a message for TA determination. For example, a network node 110 may request that the UE 120 transmits a message (e.g., RACH msg1, as described below) on an element of a first TAG, to enable the network node 110 to acquire and signal a TA command for other TAGs. In this case, the network node 110 may indicate the TA command, in an RAR message (e.g., RACH msg2, as described below), for the other TAGs based on a sub-band index, RACH occasion (RO) index, or RACH sequence, among other examples.

In some aspects, the configuration information may include an indication of a reference element. For example, the network node 110 may transmit, via vCell SI, an indication of a reference band, sub-band, cell, carrier, or CC. In this case, SSB beams of the reference element may map to ROs on each element of the vCell with RACH resources. Accordingly, the UE 120 may determine an RO in which to transmit a RACH message based on receiving an SSB beam of a reference element. In some aspects, the UE 120 may interpret the configuration information as being for a plurality of dedicated RACH resources based on an indication of a reference element for RO mapping. Additionally, or alternatively, the UE 120 may interpret an explicit indicator in the configuration information as indicating that dedicated RACH resources are assigned for each element.

In some aspects, the configuration information may identify RACH resources for different types or configurations of UEs. For example, rather than transmitting PRACHs toward a plurality of TAGs of a vCell to acquire timing for the plurality of TAGs of the vCell, a UE 120 may indicate that the UE 120 is to connect via a single TAG. In this case, the network node 110 may provide configuration information identifying first dedicated RACH resources for UEs 120 that are to connect with a single TAG or second dedicated RACH resources for UEs 120 that are to connect with a plurality of TAGs.

In some aspects, the configuration information may identify an RAR window. For example, as described in more detail below, the UE 120 may receive vCell SI associated with conveying an RAR window for monitoring for an RAR, an SCS (or reference SCS) for determining the RAR window, or another RAR window parameter. In some aspects, the configuration information may include event information. For example, a network node 110 may indicate a sequence of events associated with RACH resources. In this case, a UE 120 may use the sequence for configuring transmission of a PRACH in RACH resources to avoid ambiguity between different UEs transmitting concurrent PRACHs. For example, the network node 110 may indicate that, in order, UEs 120 are to transmit a first PRACH on a first TAG, a second PRACH on a second TAG, and a third PRACH on a third TAG. In some aspects, the configuration information may include information identifying first RACH resources and subsequent configuration information may include information identifying subsequent RACH resources. For example, when a UE 120 is configured to transmit a plurality of PRACHs associated with a plurality of TAGs, a network node 110 may indicate first RACH resources for a first PRACH in vCell SI and may include an indication of second RACH resources for a second PRACH in a first RAR triggered by the first PRACH (and third PRACH resources for a third PRACH in a second RAR triggered by the second PRACH).

In some aspects, a configuration of an acknowledgment message may be conveyed in configuration information. For example, the UE 120 may receive configuration information identifying whether a network node 110 is to transmit acknowledgments for each PRACH message, a single acknowledgment for a plurality of PRACH messages, or no acknowledgment (unless a PRACH message is missed), among other examples. Additionally, or alternatively, the UE 120 may receive information identifying one or more parameters for a PDCCH conveying an acknowledgment, such as a radio network temporary identifier (RNTI), a control resource set (CORESET), or a search space (e.g., via vCell SI configuration information).

As further shown in FIG. 7A, and by reference number 712, the UE 120 may transmit a first RACH message. For example, the UE 120 may transmit the first RACH message via the first band 702 to a network node 110. In this case, the UE 120 may use a first TA for transmission of the first RACH message. As shown by reference number 714, the UE 120 may receive a first RACH response (RAR) message. For example, the UE 120 may receive the first RAR message from a network node 110 on the first band 702. As shown by reference number 716, the UE 120 may transmit a second RACH message. For example, the UE 120 may transmit the second RACH message via the second band 704 to a network node 110. In this case, the UE 120 may use a second TA for transmission of the second RACH message. As shown by reference number 718, the UE 120 may receive a second RAR message. For example, the UE 120 may receive the second RAR message from a network node 110 on the second band 704.

In some aspects, the UE 120 may transmit a first RACH message (e.g., a PRACH, msg1, msgA, or another type of first RACH message) via one or more TAGs. For example, the UE 120 may transmit the first RACH message via a single TAG and may receive an RAR with configuration information identifying a plurality of TA commands. Additionally, or alternatively, the UE 120 may transmit the first RACH message (e.g., a PRACH) via a plurality of TAGs and may receive one or more RARs on one or more TAGs. In other words, the network node 110 may transmit, as a response to a plurality of PRACH transmissions, a single RAR for all of the plurality of PRACH transmissions, in some aspects, or a plurality of RARs for the plurality of PRACH transmissions, in some aspects.

In some aspects, the UE 120 may receive the first RAR message in an RAR window. For example, a network node 110 may configure RAR windows for each TAG and indicate the RAR windows in the configuration information. In this example, a UE 120, which transmits a PRACH on a RACH resource, may receive an RAR in a corresponding RAR window. For example, as shown in FIG. 7B, a UE 120 may transmit a first PRACH message for a first element (e.g., the first band 702) and a second PRACH message for a second element (e.g., the second band 704). Accordingly, the UE 120 may monitor for a first RAR for the first PRACH message in a first RAR window corresponding to the first PRACH message and may monitor for a second RAR for the second PRACH message in a second RAR window corresponding to the second PRACH message. In some aspects, each RAR is associated with a respective TA command. For example, the UE 120 may receive configuration information in each RAR configuring a TA command for a respective element. Accordingly, the UE 120 may receive a plurality of TA commands for a plurality of TAGs corresponding to a plurality of bands via a plurality of RARs. In some aspects, the TA commands may be indicated via an absolute value or a delta value (e.g., an offset relative to a previous or reference TA). For example, the UE 120 may receive a first TA command (e.g., an absolute value) via a first RAR (e.g., on a first TAG associated with a first PRACH) and may receive a second TA command (e.g., an offset value relative to the first TA command) via a second RAR (e.g., on a second TAG associated with a second PRACH).

In some aspects, the UE 120 may receive configuration information identifying the RAR window. For example, the UE 120 may receive vCell SI, as described above, conveying an RAR window in terms of a quantity of slots. Additionally, or alternatively, the UE 120 may receive information identifying the RAR window in terms of a subcarrier spacing (SCS), such as a reference SCS that is used for each TAG or a set of reference SCSs corresponding to a set of TAGs. In some aspects, the reference SCS may be an SCS of an element on which the first RACH message is transmitted (e.g., the first band 702) or the UE 120 may determine the reference SCS based on an indicator conveyed in configuration information (e.g., in vCell SI).

In some aspects, the UE 120 may receive a single RAR with configuration information conveying a plurality of TA commands. For example, when the UE 120 transmits a plurality of PRACH messages for a plurality of TAGs, a network node 110 may transmit an RAR message, after a last received PRACH message, conveying TA commands for each TAG of the plurality of TAGs. In this example, the UE 120 may determine a random access (RA) radio network temporary identifier (RNTI) for a physical downlink control channel (PDCCH) scheduling the RAR message based on one or more parameters across the plurality of bands on which the plurality of PRACHs are transmitted. In some aspects, the RAR message, which conveys a plurality of TA commands, may be an extended RAR format with a set of information elements for conveying the plurality of TA commands. In this case, the network node 110 may transmit the extended RAR format RAR message when the UE 120 indicates a connection to a vCell with a plurality of TAs (and associated TAGs). In some aspects, the RAR message may include an absolute TA command for each TAG. Additionally, or alternatively, the RAR message may include an absolute TA command for a first TAG and an offset value indicating a TA command for one or more second TAGs relative to the absolute TA command for the first TAG. In this example, the UE 120 may determine which TAG is a reference TAG for the absolute TA command based on an explicit indicator in, for example, a vCell SI configuration information message.

In some aspects, the UE 120 may receive an acknowledgment message for one or more PRACH messages. For example, when the UE 120 transmits one or more PRACH messages to one or more network nodes 110 on one or more bands, the UE 120 may receive one or more acknowledgment messages via one or more RAR messages, one or more DCI messages, or another type of message. In this case, the UE 120 may retransmit one or more PRACH messages for which an acknowledgment is not received. In some aspects, the acknowledgment message (or a negative acknowledgment message) may convey one or more acknowledgements via a bitmap or a list of indicators. In some aspects, the UE 120 may interpret a lack of an acknowledgment message as an implicit acknowledgment. In other words, the UE 120 may be configured to receive a negative acknowledgment when a PRACH message is not received, but may not receive any acknowledgment when all PRACH messages are received. In some aspects, an uplink grant for a subsequent RACH message (e.g., RACH msg3) may be included in the acknowledgment message or in a subsequent message. In some aspects, the network node 110 may omit an uplink grant when conveying a negative acknowledgment. Additionally, or alternatively, the network node 110 may transmit an uplink grant, but the UE 120 may consider the uplink grant invalid (and not use the uplink grant for RACH msg3) when the UE 120 determines that at least one PRACH message was unsuccessful. In some aspects, the UE 120 may receive acknowledgment information via a PDCCH. In some aspects, the UE 120 may receive an RAR with a plurality of TA commands and an uplink grant for a second RACH message (e.g., RACH msg3). In some aspects, when there is a vCell with N TAGs, the network node 110 may configure RACH resources for N-1 TAGs. In this case, the UE 120 may receive an uplink grant (e.g., with a TA command) on a last TAG, on which the UE 120 transmits a first RACH message (e.g., RACH msgA), in an RAR message. In this example, a UE 120 may transmit a second RACH message (e.g., RACH msg3) on a last (Nth) TAG.

As indicated above, FIGS. 7A-7B are provided as examples. Other examples may differ from what is described with respect to FIGS. 7A-7B.

FIG. 8 is a diagram illustrating an example process 800 performed, for example, at a UE or an apparatus of a UE. Example process 800 is an example where the apparatus or the UE (e.g., UE 120) performs operations associated with a RACH procedure on vCells.

As shown in FIG. 8, in some aspects, process 800 may include receiving configuration information identifying a virtual cell with a set of bands (block 810). For example, the UE (e.g., using reception component 1002 or communication manager 1006, depicted in FIG. 10) may receive configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located, as described above. In some aspects, the UE 120 may receive configuration information indicating a configuration of a timing command. For example, the UE 120 may receive a TA command associated with a TAG. In some aspects, the UE 120 may receive at least a portion of the configuration information as a response to a previous message, such as an RAR message.

As further shown in FIG. 8, in some aspects, process 800 may include transmitting a first RACH message on the first band using the first configuration associated with the first TAG (block 820). For example, the UE (e.g., using transmission component 1004 or communication manager 1006, depicted in FIG. 10) may transmit a first RACH message on the first band using the first configuration associated with the first TAG, as described above. In some aspects, the UE 120 may transmit one or more PRACHs on one or more bands of one or more TAGs. The UE 120 may receive one or more RAR messages or acknowledgment messages as one or more responses to the one or more PRACHs.

As further shown in FIG. 8, in some aspects, process 800 may include transmitting a second RACH message on the second band using the second configuration associated with the second TAG (block 830). For example, the UE (e.g., using transmission component 1004 or communication manager 1006, depicted in FIG. 10) may transmit a second RACH message on the second band using the second configuration associated with the second TAG, as described above. In some aspects, the second RACH message may include another PRACH on another TAG or a msg3 on another TAG.

Process 800 may include additional aspects, such as any single aspect or any combination of aspects described below or in connection with one or more other processes described elsewhere herein.

In a first aspect, the set of bands of the virtual cell includes at least one of a set of sub-bands, a set of cells, or a set of carriers.

In a second aspect, alone or in combination with the first aspect, the configuration information includes information identifying one or more RACH resource pools associated with one or more different TAGs, and the configuration information is conveyed via at least one of a system information message, a RACH message, a radio resource control message, a downlink control information message, or a MAC-CE.

In a third aspect, alone or in combination with one or more of the first and second aspects, the configuration information includes an indication of whether RACH messaging is supported across a plurality of TAGs.

In a fourth aspect, alone or in combination with one or more of the first through third aspects, the configuration information includes an indication of a reference band, and one or more beams of the reference band map to one or more resource occasions for RACH messaging on the set of bands.

In a fifth aspect, alone or in combination with one or more of the first through fourth aspects, the configuration information includes an indication of a first set of dedicated RACH resources associated with use of a plurality of TAGs for RACH messaging and a second set of dedicated RACH resources associated with use of a single TAG for RACH messaging.

In a sixth aspect, alone or in combination with one or more of the first through fifth aspects, the configuration information includes a first indication of a first RACH resource for the first TAG and a second indication of a second RACH resource for the second TAG.

In a seventh aspect, alone or in combination with one or more of the first through sixth aspects, process 800 includes receiving a first RACH response, in connection with the first TAG, in a first RACH response window corresponding to the first RACH resource, and receiving a second RACH response, in connection with the second TAG, in a second RACH response window corresponding to the second RACH resource.

In an eighth aspect, alone or in combination with one or more of the first through seventh aspects, the configuration information includes a response indication identifying a RACH response window corresponding to the first RACH resource, wherein the response indication is associated with a reference subcarrier spacing.

In a ninth aspect, alone or in combination with one or more of the first through eighth aspects, the reference subcarrier spacing is on a per-TAG basis.

In a tenth aspect, alone or in combination with one or more of the first through ninth aspects, the reference subcarrier spacing is associated with a plurality of TAGs.

In an eleventh aspect, alone or in combination with one or more of the first through tenth aspects, the reference subcarrier spacing is set in connection with at least one of the first RACH message, or the configuration information.

In a twelfth aspect, alone or in combination with one or more of the first through eleventh aspects, the configuration information includes an indication of an assignment of one or more RACH messages to one or more TAGs.

In a thirteenth aspect, alone or in combination with one or more of the first through twelfth aspects, the configuration includes a first indication of a first RACH resource for the first RACH message, and process 800 includes receiving, as a response to the first RACH message, a RACH response message including a second indication of a second RACH resource for the second RACH message.

In a fourteenth aspect, alone or in combination with one or more of the first through thirteenth aspects, process 800 includes receiving a RACH response message with a plurality of TA commands corresponding to a plurality of TAGs.

In a fifteenth aspect, alone or in combination with one or more of the first through fourteenth aspects, the RACH response message is associated with a format for conveying the plurality of TA commands in a single medium access control payload.

In a sixteenth aspect, alone or in combination with one or more of the first through fifteenth aspects, the plurality of TA commands is conveyed via at least one of a plurality of TA value indicators, or a delta value indicating a TA value relative to another TA value.

In a seventeenth aspect, alone or in combination with one or more of the first through sixteenth aspects, process 800 includes receiving, via a first response message, an acknowledgment message indicating a receipt of the first RACH message via at least one of a RACH response message, a downlink control information message, a physical downlink control channel message, or a dedicated acknowledgment message, and receiving, via a second response message, an uplink grant for the second RACH message.

In an eighteenth aspect, alone or in combination with one or more of the first through seventeenth aspects, the configuration information includes an indication of a configuration of the first response message.

In a nineteenth aspect, alone or in combination with one or more of the first through eighteenth aspects, the second response message includes a RACH response and a plurality of TA commands.

In a twentieth aspect, alone or in combination with one or more of the first through nineteenth aspects, process 800 includes receiving, as a response to at least one of the first RACH message or the second RACH message, a third response message, and the third response message includes a TA command.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node. Example process 900 is an example where the apparatus or the network node (e.g., network node 110) performs operations associated with a RACH procedure on vCells.

As shown in FIG. 9, in some aspects, process 900 may include transmitting configuration information identifying a virtual cell with a set of bands (block 910). For example, the network node (e.g., using transmission component 1104 or communication manager 1106, depicted in FIG. 11) may transmit configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located, as described above. In some aspects, the network node 110 may transmit configuration information indicating a configuration of a timing command. For example, the network node 110 may transmit a TA command associated with a TAG. In some aspects, the network node 110 may transmit at least a portion of the configuration information as a response to a previous message, such as an RAR message.

As further shown in FIG. 9, in some aspects, process 900 may include receiving a first RACH message on the first band using the first configuration associated with the first TAG (block 920). For example, the network node (e.g., using reception component 1102 or communication manager 1106, depicted in FIG. 11) may receive a first RACH message on the first band using the first configuration associated with the first TAG, as described above. In some aspects, the network node 110 may receive one or more PRACHs on one or more bands of one or more TAGs. The network node 110 may transmit one or more RAR messages or acknowledgment messages as one or more responses to the one or more PRACHs.

As further shown in FIG. 9, in some aspects, process 900 may include receiving a second RACH message on the second band using the second configuration associated with the second TAG (block 930). For example, the network node (e.g., using reception component 1102 or communication manager 1106, depicted in FIG. 11) may receive a second RACH message on the second band using the second configuration associated with the second TAG, as described above. In some aspects, the second RACH message may include another PRACH on another TAG or a msg3 on another TAG.

Process 900 may include additional aspects, such as any single aspect or any combination of aspects described below or in connection with one or more other processes described elsewhere herein.

In a first aspect, the set of bands of the virtual cell includes at least one of a set of sub-bands, a set of cells, or a set of carriers.

In a second aspect, alone or in combination with the first aspect, the configuration information includes information identifying one or more RACH resource pools associated with one or more different TAGs, and the configuration information is conveyed via at least one of a system information message, a RACH message, a radio resource control message, a downlink control information message, or a MAC-CE.

In a third aspect, alone or in combination with one or more of the first and second aspects, the configuration information includes an indication of whether RACH messaging is supported across a plurality of TAGs.

In a fourth aspect, alone or in combination with one or more of the first through third aspects, the configuration information includes an indication of a reference band, and one or more beams of the reference band map to one or more resource occasions for RACH messaging on the set of bands.

In a fifth aspect, alone or in combination with one or more of the first through fourth aspects, the configuration information includes an indication of a first set of dedicated RACH resources associated with use of a plurality of TAGs for RACH messaging and a second set of dedicated RACH resources associated with use of a single TAG for RACH messaging.

In a sixth aspect, alone or in combination with one or more of the first through fifth aspects, the configuration information includes a first indication of a first RACH resource for the first TAG and a second indication of a second RACH resource for the second TAG.

In a seventh aspect, alone or in combination with one or more of the first through sixth aspects, process 900 includes transmitting a first RACH response, in connection with the first TAG, in a first RACH response window corresponding to the first RACH resource, and transmitting a second RACH response, in connection with the second TAG, in a second RACH response window corresponding to the second RACH resource.

In an eighth aspect, alone or in combination with one or more of the first through seventh aspects, the configuration information includes a response indication identifying a RACH response window corresponding to the first RACH resource, and the response indication is associated with a reference subcarrier spacing.

In a ninth aspect, alone or in combination with one or more of the first through eighth aspects, the reference subcarrier spacing is on a per-TAG basis.

In a tenth aspect, alone or in combination with one or more of the first through ninth aspects, the reference subcarrier spacing is associated with a plurality of TAGs.

In an eleventh aspect, alone or in combination with one or more of the first through tenth aspects, the reference subcarrier spacing is set in connection with at least one of the first RACH message, or the configuration information.

In a twelfth aspect, alone or in combination with one or more of the first through eleventh aspects, the configuration information includes an indication of an assignment of one or more RACH messages to one or more TAGs.

In a thirteenth aspect, alone or in combination with one or more of the first through twelfth aspects, the configuration includes a first indication of a first RACH resource for the first RACH message, and process 900 includes transmitting, as a response to the first RACH message, a RACH response message including a second indication of a second RACH resource for the second RACH message.

In a fourteenth aspect, alone or in combination with one or more of the first through thirteenth aspects, process 900 includes transmitting a RACH response message with a plurality of TA commands corresponding to a plurality of TAGs.

In a fifteenth aspect, alone or in combination with one or more of the first through fourteenth aspects, the RACH response message is associated with a format for conveying the plurality of TA commands in a single medium access control payload.

In a sixteenth aspect, alone or in combination with one or more of the first through fifteenth aspects, the plurality of TA commands is conveyed via at least one of a plurality of TA value indicators, or a delta value indicating a TA value relative to another TA value.

In a seventeenth aspect, alone or in combination with one or more of the first through sixteenth aspects, process 900 includes transmitting, via a first response message, an acknowledgment message indicating a receipt of the first RACH message via at least one of a RACH response message, a downlink control information message, a physical downlink control channel message, or a dedicated acknowledgment message, and transmitting, via a second response message, an uplink grant for the second RACH message.

In an eighteenth aspect, alone or in combination with one or more of the first through seventeenth aspects, the configuration information includes an indication of a configuration of the first response message.

In a nineteenth aspect, alone or in combination with one or more of the first through eighteenth aspects, the second response message includes a RACH response and a plurality of TA commands.

In a twentieth aspect, alone or in combination with one or more of the first through nineteenth aspects, process 900 includes transmitting, as a response to at least one of the first RACH message or the second RACH message, a third response message, and the third response message includes a TA command.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 7A-7B. Additionally, or alternatively, the apparatus 1000 may be configured to perform one or more processes described herein, such as process 800 of FIG. 8. In some aspects, the apparatus 1000 or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The reception component 1002 may receive configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The transmission component 1004 may transmit a first RACH message on the first band using the first configuration associated with the first TAG. The transmission component 1004 may transmit a second RACH message on the second band using the second configuration associated with the second TAG.

The reception component 1002 may receive a first RACH response, in connection with the first TAG, in a first RACH response window corresponding to the first RACH resource. The reception component 1002 may receive a second RACH response, in connection with the second TAG, in a second RACH response window corresponding to the second RACH resource. The reception component 1002 may receive a RACH response message with a plurality of TA commands corresponding to a plurality of TAGs.

The reception component 1002 may receive, via a first response message, an acknowledgment message indicating a receipt of the first RACH message via at least one of a RACH response message, a downlink control information message, a physical downlink control channel message, or a dedicated acknowledgment message. The reception component 1002 may receive, via a second response message, an uplink grant for the second RACH message. The reception component 1002 may receive, as a response to at least one of the first RACH message or the second RACH message, a third response message, wherein the third response message includes a TA command.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network node, or a network node may include the apparatus 1100. In some aspects, the apparatus 1100 includes a reception component 1102, a transmission component 1104, or a communication manager 1106, which may be in communication with one another (for example, via one or more buses or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 7A-7B. Additionally, or alternatively, the apparatus 1100 may be configured to perform one or more processes described herein, such as process 900 of FIG. 9. In some aspects, the apparatus 1100 or one or more components shown in FIG. 11 may include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 or the transmission component 1104 may include or may be included in a network interface. The network interface may be configured to obtain or output signals for the apparatus 1100 via one or more communications links, such as a backhaul link, a midhaul link, or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 or the transmission component 1104. For example, the communication manager 1106 may receive information associated with configuring reception of communications by the reception component 1102 or transmission of communications by the transmission component 1104. Additionally, or alternatively, the communication manager 1106 may generate or provide control information to the reception component 1102 or the transmission component 1104 to control reception or transmission of communications.

The transmission component 1104 may transmit configuration information identifying a virtual cell with a set of bands, wherein the configuration information includes a first configuration for a first band, of the set of bands, associated with a first TAG and a second configuration for a second band, of the set of bands, associated with a second TAG, wherein the first band and the second band are non-co-located. The reception component 1102 may receive a first RACH message on the first band using the first configuration associated with the first TAG. The reception component 1102 may receive a second RACH message on the second band using the second configuration associated with the second TAG.

The transmission component 1104 may transmit a first RACH response, in connection with the first TAG, in a first RACH response window corresponding to the first RACH resource. The transmission component 1104 may transmit a second RACH response, in connection with the second TAG, in a second RACH response window corresponding to the second RACH resource. The transmission component 1104 may transmit a RACH response message with a plurality of TA commands corresponding to a plurality of TAGs.

The transmission component 1104 may transmit, via a first response message, an acknowledgment message indicating a receipt of the first RACH message via at least one of a RACH response message, a downlink control information message, a physical downlink control channel message, or a dedicated acknowledgment message. The transmission component 1104 may transmit, via a second response message, an uplink grant for the second RACH message. The transmission component 1104 may transmit, as a response to at least one of the first RACH message or the second RACH message, a third response message, wherein the third response message includes a TA command.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: receiving configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located; transmitting a first random access channel (RACH) message on the first band using the first configuration associated with the first TAG; and transmitting a second RACH message on the second band using the second configuration associated with the second TAG.
Aspect 2: The method of Aspect 1, wherein the set of bands of the virtual cell includes at least one of: a set of sub-bands, a set of cells, or a set of carriers.
Aspect 3: The method of any of Aspects 1-2, wherein the configuration information includes information identifying one or more RACH resource pools associated with one or more different TAGs, and wherein the configuration information is conveyed via at least one of: a system information message, a RACH message, a radio resource control message, a downlink control information message, or a medium access control (MAC) control element.
Aspect 4: The method of any of Aspects 1-3, wherein the configuration information includes an indication of whether RACH messaging is supported across a plurality of TAGs.
Aspect 5: The method of any of Aspects 1-4, wherein the configuration information includes an indication of a reference band, and wherein one or more beams of the reference band map to one or more resource occasions for RACH messaging on the set of bands.
Aspect 6: The method of any of Aspects 1-5, wherein the configuration information includes an indication of a first set of dedicated RACH resources associated with use of a plurality of TAGs for RACH messaging and a second set of dedicated RACH resources associated with use of a single TAG for RACH messaging.
Aspect 7: The method of any of Aspects 1-6, wherein the configuration information includes a first indication of a first RACH resource for the first TAG and a second indication of a second RACH resource for the second TAG.
Aspect 8: The method of Aspect 7, further comprising: receiving a first RACH response, in connection with the first TAG, in a first RACH response window corresponding to the first RACH resource; and receiving a second RACH response, in connection with the second TAG, in a second RACH response window corresponding to the second RACH resource.
Aspect 9: The method of Aspect 7, wherein the configuration information includes a response indication identifying a RACH response window corresponding to the first RACH resource, wherein the response indication is associated with a reference subcarrier spacing.
Aspect 10: The method of Aspect 9, wherein the reference subcarrier spacing is on a per-TAG basis.
Aspect 11: The method of Aspect 9, wherein the reference subcarrier spacing is associated with a plurality of TAGs.
Aspect 12: The method of Aspect 9, wherein the reference subcarrier spacing is set in connection with at least one of: the first RACH message, or the configuration information.
Aspect 13: The method of any of Aspects 1-12, wherein the configuration information includes an indication of an assignment of one or more RACH messages to one or more TAGs.
Aspect 14: The method of any of Aspects 1-13, wherein the configuration includes a first indication of a first RACH resource for the first RACH message; and further comprising: receiving, as a response to the first RACH message, a RACH response message including a second indication of a second RACH resource for the second RACH message.

Aspect 15: The method of any of Aspects 1-14, further comprising: receiving a RACH response message with a plurality of timing advance (TA) commands corresponding to a plurality of TAGs.

Aspect 16: The method of Aspect 15, wherein the RACH response message is associated with a format for conveying the plurality of TA commands in a single medium access control payload.

Aspect 17: The method of Aspect 15, wherein the plurality of TA commands is conveyed via at least one of: a plurality of TA value indicators, or a delta value indicating a TA value relative to another TA value.

Aspect 18: The method of any of Aspects 1-17, further comprising: receiving, via a first response message, an acknowledgment message indicating a receipt of the first RACH message via at least one of: a RACH response message, a downlink control information message, a physical downlink control channel message, or a dedicated acknowledgment message; and receiving, via a second response message, an uplink grant for the second RACH message.

Aspect 19: The method of Aspect 18, wherein the configuration information includes an indication of a configuration of the first response message.

Aspect 20: The method of Aspect 18, wherein the second response message includes a RACH response and a plurality of TA commands.

Aspect 21: The method of Aspect 18, further comprising: receiving, as a response to at least one of the first RACH message or the second RACH message, a third response message, and wherein the third response message includes a TA command.

Aspect 22: A method of wireless communication performed by a network node, comprising: transmitting configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located; receiving a first random access channel (RACH) message on the first band using the first configuration associated with the first TAG; and receiving a second RACH message on the second band using the second configuration associated with the second TAG.

Aspect 23: The method of Aspect 22, wherein the set of bands of the virtual cell includes at least one of: a set of sub-bands, a set of cells, or a set of carriers.

Aspect 24: The method of any of Aspects 22-23, wherein the configuration information includes information identifying one or more RACH resource pools associated with one or more different TAGs, and wherein the configuration information is conveyed via at least one of: a system information message, a RACH message, a radio resource control message, a downlink control information message, or a medium access control (MAC) control element.

Aspect 25: The method of any of Aspects 22-24, wherein the configuration information includes an indication of whether RACH messaging is supported across a plurality of TAGs.

Aspect 26: The method of any of Aspects 22-25, wherein the configuration information includes an indication of a reference band, and wherein one or more beams of the reference band map to one or more resource occasions for RACH messaging on the set of bands.

Aspect 27: The method of any of Aspects 22-26, wherein the configuration information includes an indication of a first set of dedicated RACH resources associated with use of a plurality of TAGs for RACH messaging and a second set of dedicated RACH resources associated with use of a single TAG for RACH messaging.

Aspect 28: The method of any of Aspects 22-27, wherein the configuration information includes a first indication of a first RACH resource for the first TAG and a second indication of a second RACH resource for the second TAG.

Aspect 29: The method of Aspect 28, further comprising: transmitting a first RACH response, in connection with the first TAG, in a first RACH response window corresponding to the first RACH resource; and transmitting a second RACH response, in connection with the second TAG, in a second RACH response window corresponding to the second RACH resource.

Aspect 30: The method of Aspect 28, wherein the configuration information includes a response indication identifying a RACH response window corresponding to the first RACH resource, wherein the response indication is associated with a reference subcarrier spacing.

Aspect 31: The method of Aspect 30, wherein the reference subcarrier spacing is on a per-TAG basis.

Aspect 32: The method of Aspect 30, wherein the reference subcarrier spacing is associated with a plurality of TAGs.

Aspect 33: The method of Aspect 30, wherein the reference subcarrier spacing is set in connection with at least one of: the first RACH message, or the configuration information.

Aspect 34: The method of any of Aspects 22-33, wherein the configuration information includes an indication of an assignment of one or more RACH messages to one or more TAGs.

Aspect 35: The method of any of Aspects 22-34, wherein the configuration includes a first indication of a first RACH resource for the first RACH message; and further comprising: transmitting, as a response to the first RACH message, a RACH response message including a second indication of a second RACH resource for the second RACH message.

Aspect 36: The method of any of Aspects 22-35, further comprising: transmitting a RACH response message with a plurality of timing advance (TA) commands corresponding to a plurality of TAGs.

Aspect 37: The method of Aspect 36, wherein the RACH response message is associated with a format for conveying the plurality of TA commands in a single medium access control payload.

Aspect 38: The method of Aspect 36, wherein the plurality of TA commands is conveyed via at least one of: a plurality of TA value indicators, or a delta value indicating a TA value relative to another TA value.

Aspect 39: The method of any of Aspects 22-38, further comprising: transmitting, via a first response message, an acknowledgment message indicating a receipt of the first RACH message via at least one of: a RACH response message, a downlink control information message, a physical downlink control channel message, or a dedicated acknowledgment message; and transmitting, via a second response message, an uplink grant for the second RACH message.

Aspect 40: The method of Aspect 39, wherein the configuration information includes an indication of a configuration of the first response message.

Aspect 41: The method of Aspect 39, wherein the second response message includes a RACH response and a plurality of TA commands.

Aspect 42: The method of Aspect 39, further comprising: transmitting, as a response to at least one of the first RACH message or the second RACH message, a third response message, and wherein the third response message includes a TA command.

Aspect 43: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-42.

Aspect 44: An apparatus for wireless communication at a device, the apparatus comprising one or more memories and one or more processors coupled to the one or more memories, the one or more processors configured to cause the device to perform the method of one or more of Aspects 1-42.

Aspect 45: An apparatus for wireless communication, the apparatus comprising at least one means for performing the method of one or more of Aspects 1-42.

Aspect 46: A non-transitory computer-readable medium storing code for wireless communication, the code comprising instructions executable by one or more processors to perform the method of one or more of Aspects 1-42.

Aspect 47: A non-transitory computer-readable medium storing a set of instructions for wireless communication, the set of instructions comprising one or more instructions that, when executed by one or more processors of a device, cause the device to perform the method of one or more of Aspects 1-42.

Aspect 48: A device for wireless communication, the device comprising a processing system that includes one or more processors and one or more memories coupled with the one or more processors, the processing system configured to cause the device to perform the method of one or more of Aspects 1-42.

Aspect 49: An apparatus for wireless communication at a device, the apparatus comprising one or more memories and one or more processors coupled to the one or more memories, the one or more processors individually or collectively configured to cause the device to perform the method of one or more of Aspects 1-42.

Aspect 50: A device comprising a processing system that includes one or more processors and one or more code-storing memories coupled with the one or more processors, the processing system configured to cause the device to perform the method of one or more of Aspects 1-42.

Aspect 51: A device comprising a processing system that includes processor circuitry and code-storing memory circuitry, the processing system configured to cause the device to perform the method of one or more of Aspects 1-42.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,'” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes processor circuitry and code-storing memory circuitry, the processing system configured to cause the UE to:
receive configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located;
transmit a first random access channel (RACH) message on the first band using the first configuration associated with the first TAG; and
transmit a second RACH message on the second band using the second configuration associated with the second TAG.

2. The UE of claim 1, wherein the set of bands of the virtual cell includes at least one of:
a set of sub-bands,
a set of cells, or
a set of carriers.

3. The UE of claim 1, wherein the configuration information includes information identifying one or more RACH resource pools associated with one or more different TAGs, and wherein the configuration information is conveyed via at least one of:
a system information message,
a RACH message,
a radio resource control message,
a downlink control information message, or
a medium access control (MAC) control element.

4. The UE of claim 1, wherein the configuration information includes an indication of whether RACH messaging is supported across a plurality of TAGs.

5. The UE of claim 1, wherein the configuration information includes an indication of a reference band, and
wherein one or more beams of the reference band map to one or more resource occasions for RACH messaging on the set of bands.

6. The UE of claim 1, wherein the configuration information includes an indication of a first set of dedicated RACH resources associated with use of a plurality of TAGs for RACH messaging and a second set of dedicated RACH resources associated with use of a single TAG for RACH messaging.

7. The UE of claim 1, wherein the configuration information includes a first indication of a first RACH resource for the first TAG and a second indication of a second RACH resource for the second TAG.

8. The UE of claim 7, wherein the processing system is configured to cause the UE to:
receive a first RACH response, in connection with the first TAG, in a first RACH response window corresponding to the first RACH resource; and
receive a second RACH response, in connection with the second TAG, in a second RACH response window corresponding to the second RACH resource.

9. The UE of claim 7, wherein the configuration information includes a response indication identifying a RACH response window corresponding to the first RACH resource, wherein the response indication is associated with a reference subcarrier spacing.

10. The UE of claim 9, wherein the reference subcarrier spacing is on a per-TAG basis.

11. The UE of claim 9, wherein the reference subcarrier spacing is associated with a plurality of TAGs.

12. The UE of claim 9, wherein the reference subcarrier spacing is set in connection with at least one of:
the first RACH message, or
the configuration information.

13. The UE of claim 1, wherein the configuration information includes an indication of an assignment of one or more RACH messages to one or more TAGs.

14. The UE of claim 1, wherein the configuration includes a first indication of a first RACH resource for the first RACH message; and
wherein the processing system is configured to cause the UE to:
receive, as a response to the first RACH message, a RACH response message including
a second indication of a second RACH resource for the second RACH message.

15. The UE of claim 1, wherein the processing system is configured to cause the UE to:
receive a RACH response message with a plurality of timing advance (TA) commands corresponding to a plurality of TAGs.

16. The UE of claim 15, wherein the RACH response message is associated with a format for conveying the plurality of TA commands in a single medium access control payload.

17. A network node, comprising:
a processing system that includes processor circuitry and code-storing memory circuitry, the processing system configured to cause the network node to:
transmit configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located;
receive a first random access channel (RACH) message on the first band using the first configuration associated with the first TAG; and
receive a second RACH message on the second band using the second configuration associated with the second TAG.

18. The network node of claim 17, wherein the set of bands of the virtual cell includes at least one of:
a set of sub-bands,
a set of cells, or
a set of carriers.

19. The network node of claim 17, wherein the configuration information includes information identifying one or more RACH resource pools associated with one or more different TAGs, and
wherein the configuration information is conveyed via at least one of:
a system information message,
a RACH message,
a radio resource control message,
a downlink control information message, or
a medium access control (MAC) control element.

20. A method of wireless communication performed by a user equipment (UE), comprising:
receiving configuration information identifying a virtual cell with a set of bands, wherein the configuration information includes a first configuration for a first band, of the set of bands, associated with a first timing advance group (TAG) and a second configuration for a second band, of the set of bands, associated with a second TAG, wherein the first band and the second band are non-co-located;
transmitting a first random access channel (RACH) message on the first band using the first configuration associated with the first TAG; and
transmitting a second RACH message on the second band using the second configuration associated with the second TAG.
